(19) United States
(12) Patent Application Publication
(10) Pub. No.: US 2009/0225427 A1
(43) Pub. Date: Sep. 10, 2009

(54) OPTICALLY MODIFIED THREE-DIMENSIONAL OBJECT

(75) Inventors: Evelyn Mcgee Deliso, Ann Arbor, MI (US); Mei Wen, Southgate, MI (US); Jennifer Kruschwitz, Rochester, NY (US)

Correspondence Address: GIFFORD, KRASS, SPRINKLE,ANDERSON & CITKOWSKI, P.C, PO BOX 7021, TROY, MI, 48007-7021, US

(73) Assignee: Masco Corporation

(21) Appl. No.: 12/045,066

(22) Filed: Mar. 10, 2008

(51) Int. Cl. B32B 7/02; B32B 15/04; G02F 1/15; G02B 1/10

(52) U.S. Cl. 359/586; 428/212; 428/457; 428/469; 428/450; 428/472; 428/332; 359/265; 359/359

(57) ABSTRACT

An optically modified three-dimensional object includes a metal substrate material. At least one dielectric material is on the metal substrate material. A visual property of the substrate material and visible light reflected by the at least one dielectric material create a desired visual appearance of the three-dimensional object.

### FIELD OF THE INVENTION

The invention relates to optical coatings for three-dimensional objects.

### BACKGROUND OF THE INVENTION

Optical coatings are known in the art and may be used on various substrates. For example, optical coatings may be used on glass or semiconductor substrates to create photonic band gap materials that may be used for telecommunication systems at specific electromagnetic wavelengths. Similarly, optical coatings for multilayer dielectric mirrors positioned on a glass substrate may be used to create mirror structures having high reflectivity at various wavelengths.

These optical components may be created by depositing optical layers using various procedures including chemical vapor deposition, physical vapor deposition, metal organic chemical vapor deposition, arc vapor deposition, and other procedures. These processes are designed to typically apply layers on a flat substrate. The processes do not lend themselves to application on a three-dimensional object such that a thin coating may be uniformly and accurately positioned on the entire surface of the three-dimensional object. There is therefore a need in the art for an optical coating that may be applied to a three-dimensional object to optically modify the three-dimensional object. Additionally, there is a need in the art for an optically modified three-dimensional object that has a metal substrate such that a coating may be applied to the three-dimensional object such that a visual property of the substrate material in combination with a visible light spectrum can be modified to create a desired visual appearance.

Various three-dimensional objects may have applied thereon a surface coating of a decorative material to enhance the visual appearance of the object. One such coating known in the art is a chrome coating that may be applied to a metal surface to create an aesthetically pleasing appearance. Chrome is typically electroplated onto a metal surface using a hexavalent chromium electroplating bath. There are environmental and health and safety reasons to minimize or eliminate the use of hexavalent chromium which is a known carcinogen. Additionally, various social policies and concerns are in place to lower the amount of chromium used to produce various consumer goods. Therefore, there is a need in the art for an optically modified three-dimensional object that mimics the appearance of a highly reflective chromium surface without the use of hexavalent chromium during the manufacturing process. There is also a need in the art for creating decorative finishes on a three dimensional object using an optically modifying coating.

### SUMMARY OF THE INVENTION

In one aspect, there is disclosed an optically modified three-dimensional object that includes a metal substrate material. At least one dielectric material is on the metal substrate material. A visual property of the substrate material and visible light reflected by the at least one dielectric material create a desired visual appearance of the three-dimensional object.

In another aspect, there is disclosed an optically modified three-dimensional object that includes a metal substrate material. At least one dielectric material is on the metal substrate material. The three-dimensional object has a chrome-like appearance without the use of chromium.

In another aspect, an optically modified three-dimensional object includes a metal substrate material. A plurality of alternating layers of low and high refractive index materials is on the metal substrate material. A visual property of the substrate material and visible light reflected by the plurality of alternating layers of low and high refractive index materials creates a desired visual appearance of the three-dimensional object.

### BRIEF DESCRIPTION OF THE DRAWINGS

FIG. 1 is a graphical depiction of a portion of a three-dimensional object detailing the substrate and the at least one dielectric material;

FIG. 2 is a graphical depiction of a portion of a three-dimensional object detailing the substrate and alternating layers of high and low refractive index;

FIG. 3 is a graphical depiction of a portion of a three-dimensional object detailing substrate, a protective layer and alternating layers of high and low refractive index;

FIG. 4 is a graphical depiction of a portion of a three-dimensional object detailing the substrate, alternating layers of high and low refractive index and a top layer of zirconium oxide;

FIG. 5 is a graphical depiction of a portion of a three-dimensional object detailing the substrate, a protective layer, alternating layers of high and low refractive index, and a top layer of zirconium oxide;

FIG. 6 is a plot of the reflectance versus wavelength at 7° of angle of incidence before and after deposition for an embodiment detailed in Example 1;

FIG. 7 is a TEM cross-sectional image of a sample of the embodiment of FIG. 6;

FIG. 8 is a plot of the reflectance versus wavelength at various angles of incidence before and after deposition for an embodiment detailed in Example 2.

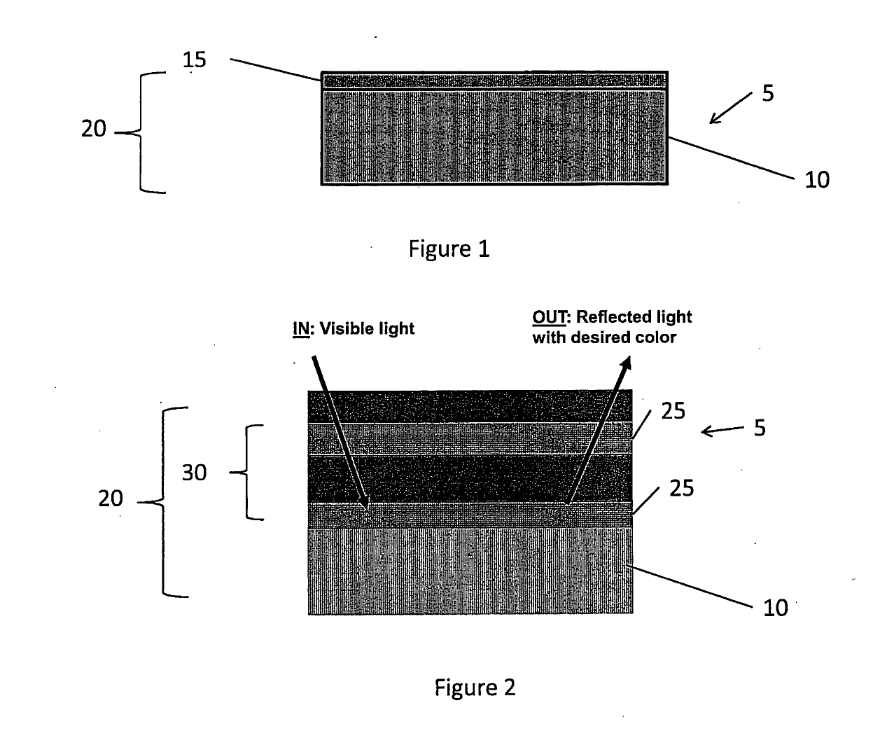

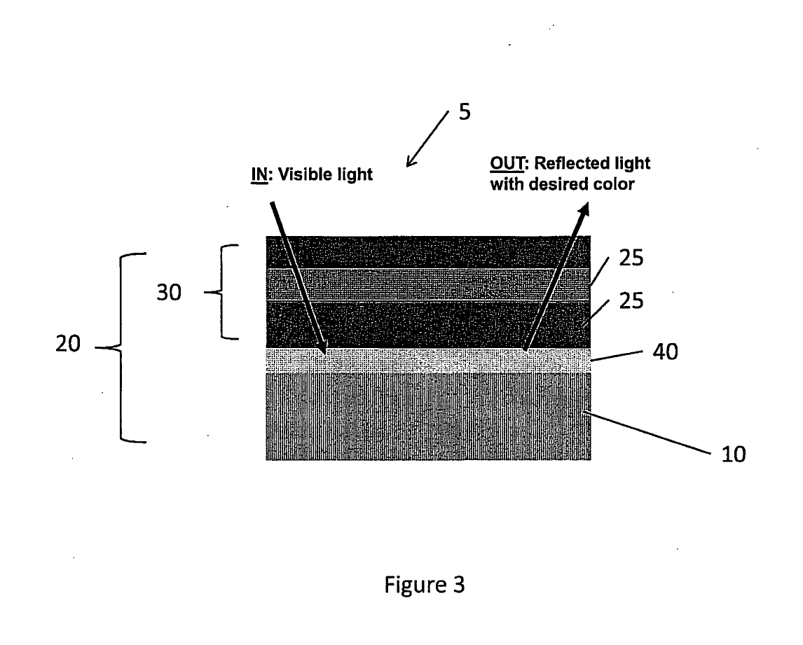

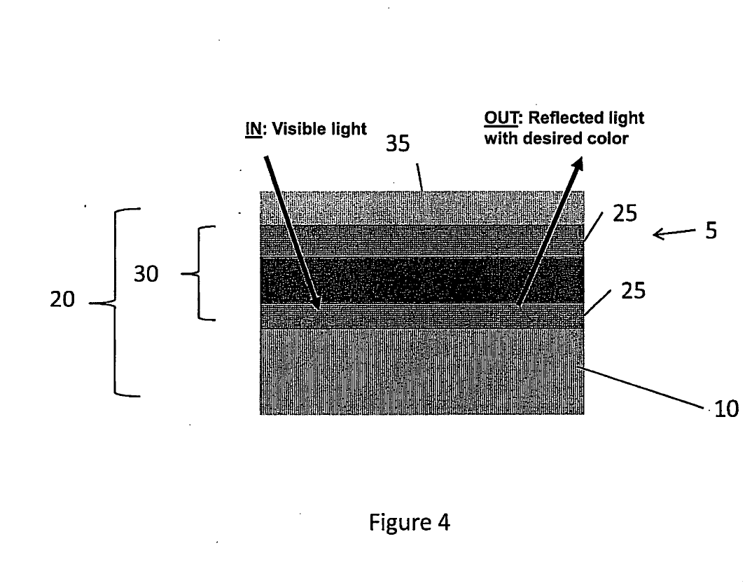

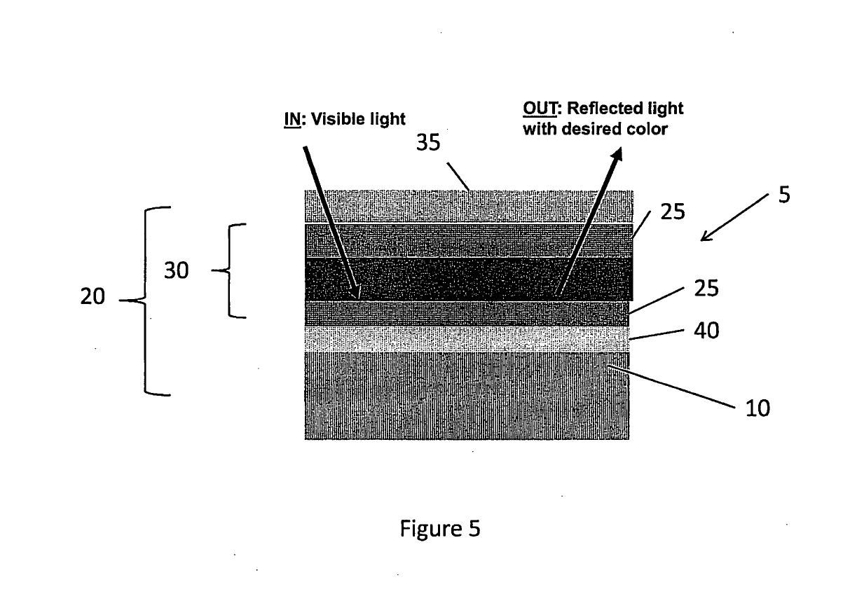

### DETAILED DESCRIPTION OF THE PREFERRED EMBODIMENTS

Referring to the figures, there are shown portions of an optically modified three-dimensional object 5 that includes a metal substrate material 10. At least one dielectric material 15 is on the metal substrate material 10. The visual property of the substrate material 10 and visible light reflected by the at least one dielectric material 15 create a desired visual appearance of the three-dimensional object 5. The combination of the metal substrate material 10 and at least one dielectric material 15 creates an optical interference coating 20 that may be used to create a desired color appearance on the surface of the three-dimensional object 5. Manipulating the reflectance of light in the visible range to which the human eye is sensitive allows for various desired reflective colors to be viewed on a surface of the optically modified three-dimensional object 5. In one aspect, the optical interference coating 20 may provide a color-correcting property to mimic other metals and create specific color appearances. The optical interference coating 20 is a combination of the color of the underlying substrate material 10 and the reflected visible light coming off the surface of the at least one dielectric material 15 applied to the three-dimensional object 5.

In one aspect, the at least one dielectric material 15 may include a plurality of alternating layers 25 of high and low refractive index materials defining a dielectric stack 30. The dielectric stack 30 may have a total thickness of from 0.4 to 620 nanometers. The dielectric stack 30 total thickness should not exceed 1200 nanometers as light is reflected in the visible range and thicknesses greater than that would affect the visible spectrum. In one aspect, the high and low refractive index materials may have a refractive index of from 1.45 to 2.7 as measured at the wavelength of 600 nanometers.

Additionally, the thickness of each layer 25 of the dielectric stack 30 may be different or the same as other layers 25 within the stack 30. Manipulation of the thicknesses of the various layers 25 in the dielectric stack 30 may be utilized to provide a desired appearance. In one aspect, the thickness of each layer may vary from 0.4 to 250 nanometers.

The metallic substrate material 10 should have a surface that is relatively free from surface roughness as marks and blemishes may create scatter of the visible spectrum at the surface. In one aspect, the reflectance at the surface of the optically modified three-dimensional object 5 should be relatively high, such as above 60% and even more preferably above 70%. However, various total reflectance properties may be adjusted and modified to mimic a specific surface appearance such that the three-dimensional object 5 can be tailored to have a desired appearance.

In another aspect, the appearance or reflected color of the three-dimensional object 5 may change with the viewing angle relative to the object. Alternatively, the appearance or reflected color of the object may remain constant with the viewing angle of the object. Various thicknesses and types of dielectric materials 15 may be selected. Thus, the appearance can be tailored to either change with the viewing angle or remain constant.

Various dielectric materials 15 may be utilized for the optical interference coating 20 applied to the three-dimensional object 5. Dielectric materials 15 may include aluminum oxide, titanium oxide, silicon dioxide, tantalum oxide, niobium oxide, zirconium oxide, hafnium oxide, tin oxide, lanthanum oxide, yttrium oxide, cesium oxide, aluminum nitride, tantalum nitride, niobium nitride, titanium nitride, molybdenum nitride zirconium nitride, hafnium nitride, gallium nitride, titanium aluminum nitride, aluminum titanium oxide, indium doped tin oxide (ITO) and antimony doped tin oxide (ATO). The various dielectric materials 15 may have varying thicknesses when applied as layers 25 in a dielectric stack 30 and may be positioned at various strata within the layered structure to produce a desired appearance on the three-dimensional object 5. As stated above, the dielectric stack may include various dielectric materials and in one aspect includes more than two different materials positioned within the stack. Various layer structures and thicknesses may be utilized with several exemplary embodiments detailed in the example section below.

In one aspect, the modified three-dimensional object 5 may include a layer of zirconium oxide 35 positioned on top of the at least one dielectric material 15. The zirconium oxide layer 35 positioned as a top layer of a multilayer dielectric stack 30 may provide good chemical resistance to both acids and bases. The zirconium oxide layer 35 provides good chemical resistance to basic chemicals as well as provides a color correction or appearance modifying property.

The substrate material 10 may be selected from various metals including brass, nickel, steel, or combinations thereof. Additionally, the metal substrate 10 may further include a protective layer 40 applied to a surface of the metal substrate 10. One example of a metal substrate material 10 having a protective layer 40 is a 70/30 brass object having a nickel coating applied thereto. Such a substrate material 10 may be used on a three-dimensional object that is potentially exposed to water to prevent the galvanic corrosion of the three-dimensional object. In this manner, if the multilayer dielectric stack 30 is compromised or damaged the galvanic corrosion resistance of the substrate material 10 will prevent further damage to the three-dimensional object 5.

Again as stated above, the optical property of the substrate material 10 in combination with the at least one dielectric material 15 modifies the appearance of the three-dimensional object 5. In one aspect, the appearance of the object may be designed to appear to be bright chrome without the use of chromium. Further details of exemplary coatings allowing for the appearance of an object to mimic bright chrome, as well as other appearances will be detailed in the example section below.

### EXAMPLES

### Example 1

### Chromelike Appearance with Eleven Layer Stack of SiO2/TiO2/Al2O3 on Brass Substrate

Samples were prepared in the form of panels (size of 3 inch×8 inch with thickness of 0.032 inch) of 70/30 brass. The samples were polished using conventional polishing mops and compounds. They were placed in a conventional ultrasonic alkaline cleaner bath. The ultrasonic cleaner bath had a pH of 8.9-9.2, was maintained at a temperature of about 160-180 F, and contained the conventional and well known soaps, detergents, defloculants and the like. After the ultrasonic cleaning the samples were rinsed and dried.

The samples were placed in the Atomic Layer Deposition (ALD) reaction chamber. The process conditions, including pressure and temperature were adjusted to meet the requirements of the process chemistry and the substrate materials. A multi-layer coating of dielectric oxides shown in the Table 1 as shown below was deposited on the samples.

TABLE 1
The multi-layer coating of dielectric oxides in the Example 1.

| Layer | Material | Thickness (nm) |
|---|---|---|
| 1 | SiO2 | 40 |
| 2 | TiO2 | 40 |
| 3 | SiO2 | 59 |
| 4 | TiO2 | 53 |
| 5 | SiO2 | 18 |
| 6 | TiO2 | 39 |
| 7 | Al2O3 | 79 |
| 8 | TiO2 | 16 |
| 9 | Al2O3 | 25 |
| 10 | TiO2 | 59 |
| 11 | Al2O3 | 48 |

Total layer thickness = 476 nm.

Atomic Layer Deposition is a film deposition technique that is based on sequential, self-limiting gas-solid reactions. For the growth of a film, a pulse of a first precursor was vaporized from the external source and introduced into the reaction chamber. The vapor contacted the surface of the samples and reacted with the surface species. After an appropriate interval, the excess of the vapor and any volatile reaction products were evacuated with a purge gas such as N2. Subsequently, a second precursor vapor was introduced into the chamber and reacted with the surface of samples. Then the excess of the vapor and any volatile reaction products were evacuated with the purge gas again. Thus one cycle of a film growth was completed and the cycle was as follows: introducing a pulse of a first precursor vapor, keeping the precursor in the reaction chamber, exhausting the precursor vapor and any volatile reaction products by a purge gas, introducing a pulse of a second precursor vapor, keeping the precursor in the reaction chamber, and exhausting the precursor vapor and any volatile reaction products again by a purge gas. This cycle was repeated until achieving desirable thickness. For the growth of the TiO2 layer, possible precursors include the titanium halides, e.g. titanium tetrachloride (TiCl4) and H2O or the titanium alkoxides, e.g. titanium butoxide and H2O. The growth of ZrO2 and Al2O3 followed the same process except different precursors were used. The possible precursors can be found in the literatures.

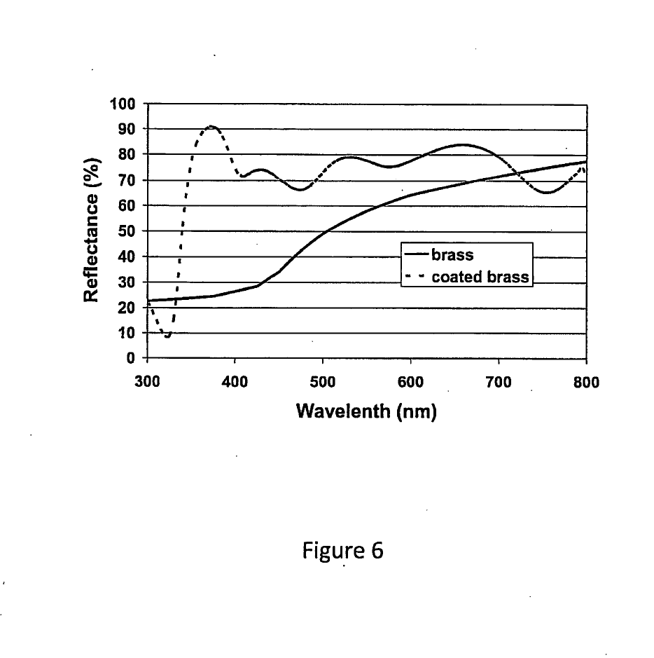

The reflectance of the sample before and after deposition was measured at 7 degree of angle of incidence using Cary 500E Uv-Vis-NIR spectrophotometer. The reflectance of sample in the visible wavelength region changed after deposition of the multilayer coating as shown in the FIG. 6. This reflectance change resulted in the change of color of samples, which is clearly shown in Table 7. This sample has the reflectivity and appearance almost identical to that of a bright electroplated chrome surface.

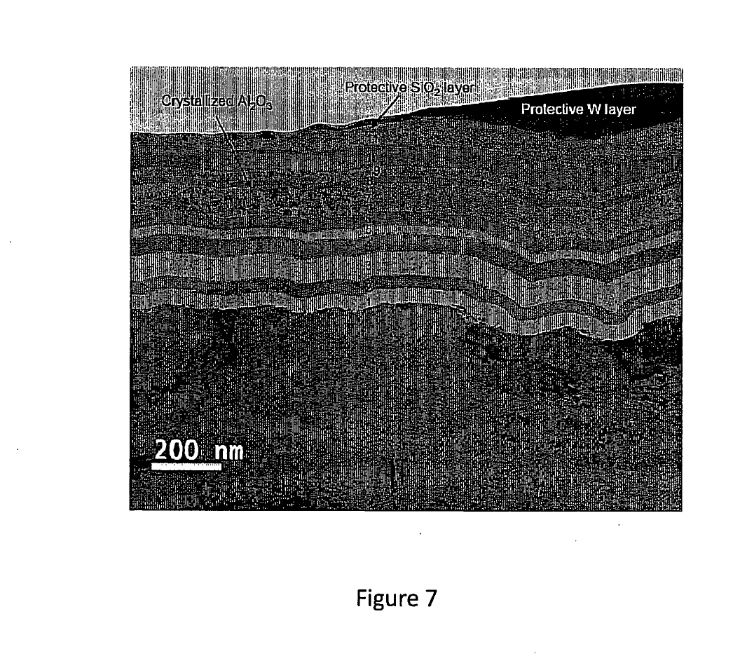

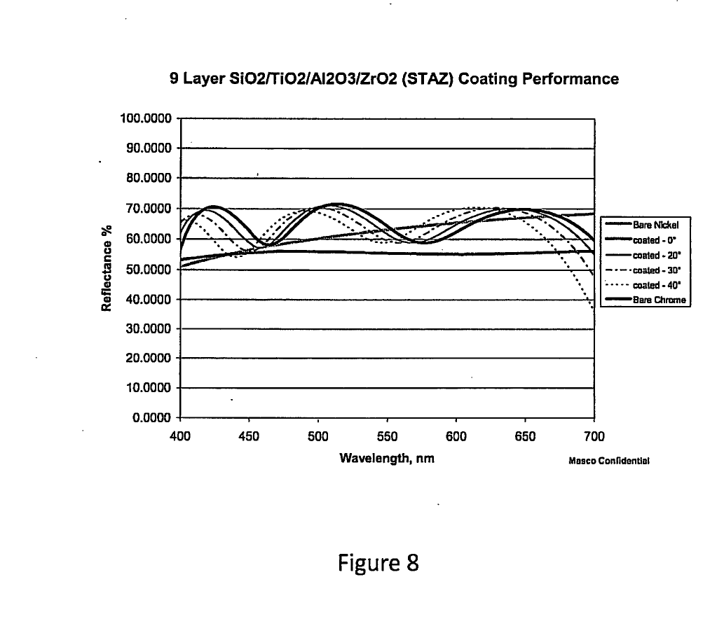

The actual film thickness was measured from the cross sectional Transmission Electron Microscopy (TEM) image FIG. 7. The thickness of each layer in the sample was quite uniform and the coating is conformal.

### Example 2

### Chromelike Appearance with Nine Layer Stack of TiO2/SiO2/Al2O3/ZrO2 on Nickel Leveled Brass Having Good Chemical and Corrosion Resistance

Samples were prepared in the form of panels (size of 3 inch×8 inch with thickness of 0.032 inch) of 70/30 brass. The samples were polished using conventional polishing mops and compounds. They were placed in a conventional ultrasonic alkaline cleaner bath. The ultrasonic cleaner bath had a pH of 8.9-9.2, was maintained at a temperature of about 160-180 F, and contained the conventional and well known soaps, detergents, defloculants and the like. After the ultrasonic cleaning the samples were rinsed and placed in a conventional alkaline electro cleaner bath. The electro cleaner bath was maintained at a temperature of about 140-180 F, a pH of about 10.5-11.5, and contained standard and conventional detergents. The samples were then rinsed twice and placed in a conventional acid activator bath. The acid activator bath had a pH of about 2.0-3.0, was at an ambient temperature, and contained a sodium fluoride based acid salt. The samples were then rinsed twice and placed in a bright nickel plating bath. The bright nickel bath was generally a conventional bath which was maintained at a temperature of 130-150 F, a pH of about 4.0, contained NiSO4, NiCl2, boric acid, and brighters. A bright nickel layer was deposited on the sample surface. The nickel plated samples were rinsed three times and dried.

Similar to Example 1, the samples were placed in the ALD reaction chamber and a multi-layer coating of dielectric oxides as shown in Table 2 below was deposited on the samples.

TABLE 2
The multi-layer coating of dielectric oxides in the Examples 2 and 4.

| Layer | Material | Thickness (nm) |
|---|---|---|
| 1 | TiO2 | 96 |
| 2 | SiO2 | 68 |
| 3 | TiO2 | 68 |
| 4 | SiO2 | 29 |
| 5 | TiO2 | 21 |
| 6 | Al2O3 | 81 |
| 7 | TiO2 | 55 |
| 8 | Al2O3 | 42 |
| 9 | ZrO2 | 20 |

Total layer thickness = 480 nm.

### Example 3

### Pink/Green Appearance at Different Angle of Incidence with Eight Layer TiO2/SiO2/Al2O3 Stack on Nickel Leveled Brass

As in the Example 2, the samples were cleaned and electroplated with a nickel layer. Similar to Example 2, the nickel plated samples were deposited with a multi-layer coating of dielectric oxides shown in the Table 3 using the Atomic Layer Deposition process described above.

TABLE 3
The multi-layer coating of dielectric oxides in the Examples 3 and 5.

| Layer | Material | Thickness (nm) |
|---|---|---|
| 1 | TiO2 | 96 |
| 2 | SiO2 | 68 |
| 3 | TiO2 | 68 |
| 4 | SiO2 | 29 |
| 5 | TiO2 | 21 |
| 6 | Al2O3 | 81 |
| 7 | TiO2 | 55 |
| 8 | Al2O3 | 42 |

Total layer thickness = 460 nm.

### Example 4

### Yellowish Appearance with Nine Layer Stack of TiO2/SiO2/Al2O3/ZrO2 on Brass Having Good Chemical Resistance

As in the Example 1, the samples were subjected to ultrasonic alkaline cleaning, rinsing and drying. The samples were then deposited with a multi-layer coating of dielectric oxides shown in Table 2 (see Example 2) above using Atomic Layer Deposition.

### Example 5

### Yellowing Appearance with Eight Layer TiO2/SiO2/Al2O3 Stack on Brass

As in the Example 1, the samples were subjected to ultrasonic alkaline cleaning, rinsing and drying. The samples were then deposited with a multi-layer coating of dielectric oxides shown in Table 3 (see Example 3) using Atomic Layer Deposition process similar to the Example 1.

### Example 6

### Chromelike Appearance with Ten Layer SiO2/Al2O3/TiO2 on Brass

As in the Example 1, the samples were subjected to ultrasonic alkaline cleaning, rinsing and drying. The samples were then deposited with a multi-layer coating of dielectric oxides shown in the Table 4 below using Atomic Layer Deposition process similar to the Example 1.

TABLE 4
The multi-layer coating of dielectric oxides in the Example 6.

| Layer | Material | Thickness (nm) |
|---|---|---|
| 1 | SiO2 | 34 |
| 2 | Al2O3 | 18 |
| 3 | TiO2 | 31 |
| 4 | Al2O3 | 85 |
| 5 | TiO2 | 30 |
| 6 | Al2O3 | 178 |
| 7 | TiO2 | 6 |
| 8 | Al2O3 | 13 |
| 9 | TiO2 | 40 |
| 10 | Al2O3 | 86 |

Total layer thickness = 521 nm.

### Example 7

### Pink Color on Brass

As in the Example 1, the samples were subjected to ultrasonic alkaline cleaning, rinsing and drying. The samples were then deposited with a multi-layer coating of dielectric oxides shown in the Table 5 using Atomic Layer Deposition process similar to the Example 1.

TABLE 5
The multi-layer coating of dielectric oxides in the Examples 7 and 9.

| Layer | Material | Thickness (nm) |
|---|---|---|
| 1 | TiO2 | 23 |
| 2 | SiO2 | 91 |
| 3 | TiO2 | 47 |
| 4 | SiO2 | 50 |
| 5 | TiO2 | 56 |
| 6 | SiO2 | 118 |

Total layer thickness = 385 nm.

### Example 8

### Ten Layer TiO2/Al2O3 with Lower Processing Temperature

As in the Example 1, the samples were subjected to ultrasonic alkaline cleaning, rinsing and drying. The samples were then deposited with a multi-layer coating of dielectric oxides shown in the Table 6 below using Atomic Layer Deposition process. The process was similar to the Example 1 except that the chamber was heated to a lower temperature than the temperature used in the example 1.

TABLE 6
The multi-layer coating of dielectric oxides in the Example 8.

| Layer | Material | Thickness (nm) |
|---|---|---|
| 1 | TiO2 | 20 |
| 2 | Al2O3 | 98 |
| 3 | TiO2 | 38 |
| 4 | Al2O3 | 83 |
| 5 | TiO2 | 51 |
| 6 | Al2O3 | 78 |
| 7 | TiO2 | 20 |
| 8 | Al2O3 | 70 |
| 9 | TiO2 | 62 |
| 10 | Al2O3 | 96 |

Total layer thickness = 616 nm.

### Example 9

### Pink Color on Brass Using E-Beam Deposition

As in the Example 1, the samples were subjected to ultrasonic alkaline cleaning, rinsing and drying. The samples were then deposited with a multi-layer coating of dielectric oxides shown in the Table 5 (see Example 7) using Electron Beam Physical Vapor Deposition.

Color Measurement Results for Examples

The color of the samples before and after deposition was measured using MinoLTA CR-200 calorimeter under D65 illumination. A specific color is defined by the combination of three specific parameters in which “L” is a measure of the lightness of an object, “a” is a measure of the redness or greenness, and “b” is a measure of yellowness or blueness. The color measurement results are shown in Table 7. It is clear that a multi-layer coating of dielectric oxides could color correct the reflectance of metals to create new colors. Specifically, the samples with the coating in the Example 2 could have the color almost identical to conventional chrome finish.

Chemical and Corrosion Test Results for Examples

Chemical tests were performed per the procedure as follows. Droplets (50 μl) of each chemical were placed on the samples and allowed to sit at ambient conditions for 16 hours. Visual observations were made after removing the droplets with a DI water rinse. The corrosion tests were performed per ASTM standard B-368 and visual observations were made after removing the samples out of the corrosion test chamber. The test results are shown in the Table 8. Chemical resistance especially base resistance is significantly improved by having ZrO2 as the outmost layer. Plated nickel layer provides good corrosion resistance in addition to dielectric oxides coating on the brass metal. The samples in the Example 2 having ZrO2 and nickel layers show the best chemical and corrosion resistance.

### Example 10

### Chromelike Appearance with 9 Layer SiO2/TiO2/Al2O3 on Steel

An optical design using 9 layers of SiO2/TiO2/Al2O3 was created to produce chromelike appearance on a steel substrate as shown in Table 9 below.

TABLE 9
The multi-layer coating of dielectric oxides in Example 10.

| Layer | Material | Thickness (nm) |
|---|---|---|
| 1 | SiO2 | 61 |
| 2 | TiO2 | 50 |
| 3 | SiO2 | 91 |
| 4 | TiO2 | 42 |
| 5 | SiO2 | 21 |
| 6 | TiO2 | 18 |
| 7 | Al2O3 | 120 |
| 8 | TiO2 | 77 |
| 9 | Al2O3 | 66 |

Total layer thickness = 546 nm.

### Example 11

### Cyan or Blue Color on Nickel

An optical design using 13 layers of TiO2/Al2O3/SiO2/Ta2O5 was created to produce a blue color on a nickel substrate as shown in Table 10 below.

TABLE 10
The multi-layer coating of dielectric oxides in Example 11.

| Layer | Material | Thickness (nm) |
|---|---|---|
| 1 | TiO2 | 65 |
| 2 | Al2O3 | 2 |
| 3 | SiO2 | 29 |
| 4 | Al2O3 | 13 |
| 5 | TiO2 | 120 |
| 6 | Al2O3 | 49 |
| 7 | Ta2O5 | 17 |
| 8 | TiO2 | 74 |
| 9 | Ta2O5 | 1 |
| 10 | Al2O3 | 28 |
| 11 | Ta2O5 | 30 |
| 12 | TiO2 | 48 |
| 13 | SiO2 | 124 |

Total layer thickness = 600 nm.

### Example 12

### Cyan or Blue Color on Nickel

A single layer of TiO2, 57 nm thick, deposited by ALD is used to create a blue color on a nickel substrate.

### Example 13

### Green Color on Nickel

An optical design using 15 layers of TiO2/Al2O3/SiO2/Ta2O5 is used to create a green color on a nickel substrate as shown in Table 11 below.

TABLE 11
The multi-layer coating of dielectric oxides in Example 13.

| Layer | Material | Thickness (nm) |
|---|---|---|
| 1 | TiO2 | 46 |
| 2 | Al2O3 | 6 |
| 3 | SiO2 | 18 |
| 4 | Al2O3 | 6 |
| 5 | TiO2 | 71 |
| 6 | Ta2O5 | 3 |
| 7 | TiO2 | 79 |
| 8 | Al2O3 | 29 |
| 9 | Ta2O5 | 6 |
| 10 | TiO2 | 100 |
| 11 | SiO2 | 20 |
| 12 | Al2O3 | 24 |
| 13 | Ta2O5 | 29 |
| 14 | TiO2 | 45 |
| 15 | SiO2 | 94 |

Total layer thickness = 576 nm.

### Example 14

### Green Color on Nickel

A single layer of TiO2, 210.9 nm thick, deposited by ALD is used to create a green color on a nickel substrate.

### Example 15

### Purple Color on Nickel

An optical design using 9 layers of TiO2/SiO2/Al2O3/Ta2O5 is used to create a purple color on a nickel substrate as shown in Table 12 below.

TABLE 12
The multi-layer coating of dielectric oxides in Example 15.

| Layer | Material | Thickness (nm) |
|---|---|---|
| 1 | TiO2 | 42 |
| 2 | SiO2 | 86 |
| 3 | Al2O3 | 10 |
| 4 | SiO2 | 42 |
| 5 | TiO2 | 59 |
| 6 | Ta2O5 | 20 |
| 7 | Al2O3 | 16 |
| 8 | Ta2O5 | 9 |
| 9 | TiO2 | 28 |

Total layer thickness = 312 nm.

### Example 16

### Purple Color on Nickel

A single layer of TiO2, 45.6 nm thick, deposited by ALD is used to create a purple color on a nickel substrate.

### Example 17

### Inventive Coating on Three Dimensional Faucet Part

An optical interference coating was deposited on to a faucet handle by atomic layer deposition. The optical interference stack, 9 layer TiO2/SiO2/Al2O3/ZrO2 stack, was the optical interference coating that was used as shown in Table 2 (see Example 2). The optical effect of a chromelike appearance with the multilayer stack was maintained around the entire part, thus proving the manufacturability of this process.

TABLE 7
Color space of various samples.

| | | Nickel | | | | | | | | | | |
|---|---|---|---|---|---|---|---|---|---|---|---|---|
| Color | | Plated | Conventional | Examples | | | | | | | | |
| Space | Brass | Brass | Chrome Finish | 1 | 2 | 3 | 4 | 5 | 6 | 7 | 8 | 9 |
| L | 72.6 | 67.1 | 68.5 | 74.8 | 67.1 | 67.7 | 76.7 | 75.7 | 75.6 | 66.3 | 67.3 | 65.4 |
| a | −2.2 | 0.5 | −0.5 | −1.0 | 1.9 | 17.1 | −5.7 | 2.0 | −0.3 | 24.8 | 18.7 | 30.8 |
| b | 26.2 | 4.8 | −1.7 | 2.2 | −1.7 | −9.1 | 23.9 | 14.3 | 5.5 | −9.7 | 2.9 | −13.7 |

TABLE 8
Chemical and corrosion tests of samples.

| | Example 2 | Example 3 | Example 4 | Example 5 |
|---|---|---|---|---|
| NaOH 6N | No visual effect | Coating totally lost | Very slight haze | Coating totally lost |
| Phosphoric acid | No visual effect | Discoloration | Slight discoloration | Slight discoloration |
| 42.5% | | | | |
| HCl 6N | Slight haze | Discoloration | Discoloration | Discoloration |
| Methanol 100% | No visual effect | No visual effect | No visual effect | No visual effect |
| Triton X-100 | No visual effect | No visual effect | No visual effect | Very slight haze |
| 100% | | | | |
| Corrosion test | No visual effect | A few tiny spots with | Significant corrosion | Significant corrosion |
| 96 hours | | coating peeling | and coating peeling | and coating peeling |

1. An optically modified three-dimensional object comprising:
a metal substrate material;
at least one dielectric material on the metal substrate material;
wherein a visual property of the substrate material and visible light reflected by the at least one substrate material and dielectric material create a desired visual appearance of the three-dimensional object.

2. The optically modified three-dimensional object of claim 1 wherein the at least one dielectric material includes a plurality of alternating layers of low and high refractive index materials defining a dielectric stack.

3. The optically modified three-dimensional object of claim 2 wherein the dielectric stack has a total thickness of from 0.4 to 620 nanometers.

4. The optically modified three-dimensional object of claim 2 wherein the thickness of each layer has a thickness of from 0.4 to 250 nanometers.

5. The optically modified three-dimensional object of claim 2 wherein the high and low refractive index materials have a refractive index of from 1.45 to 2.7 as measured at the wavelength of 600 nanometers.

6. The optically modified three-dimensional object of claim 1 wherein a total reflectance at a surface of the object is greater than 60 percent.

7. The optically modified three-dimensional object of claim 1 wherein the at least one dielectric material is selected from the group consisting of: Al₂O₃, TiO₂, SiO₂, Ta₂O₅, Nb₂O₅, ZrO₂, HfO₂, SnO₂, La₂O₃, Y₂O₃, CeO₂, AlN, TaN, NbN, TiN, MoN, ZrN, HFN, GaN, TiAlN, AlTiO, ITO and ATO.

8. The optically modified three-dimensional object of claim 1 including a layer of ZrO₂ positioned on top of the at least one dielectric material.

9. The optically modified three-dimensional object of claim 1 wherein an appearance or reflected color of the object changes with the viewing angle relative to the object.

10. The optically modified three-dimensional object of claim 1 wherein an appearance or reflected color of the object stays constant with the viewing angle relative to the object.

11. The optically modified three-dimensional object of claim 1 wherein the substrate material is selected from brass, nickel, steel, or combinations thereof.

12. The optically modified three-dimensional object of claim 1 wherein the metal substrate further includes a protective layer applied to a surface of the metal substrate.

13. The optically modified three-dimensional object of claim 2 wherein the dielectric stack includes more than two different materials.

14. The optically modified three-dimensional object of claim 1 wherein the appearance of the object appears to be bright chrome without the use of chromium.

15. The optically modified three-dimensional object of claim 1 having a chrome-like appearance wherein the at least one dielectric material includes 11 layers ordered as follows from a 70/30 brass substrate material: layer 1 SiO₇, layer 2 TiO₂, layer 3 SiO₂, layer 4 TiO₂, layer 5 SiO₂, layer 6 TiO₂, layer 7 Al₂O₃, layer 8 TiO₂, layer 9 Al₂O₃, layer 10 TiO₂, layer 11 Al₂O₃.

16. The optically modified three-dimensional object of claim 1 having a yellowish appearance wherein the at least one dielectric material includes 9 layers ordered as follows from a 70/30 brass substrate material: layer 1 TiO₂, layer 2 SiO₂, layer 3 TiO₂, layer 4 SiO₂, layer 5 TiO₂, layer 6 Al₂O₃, layer 7 TiO₂, layer 8 Al₂O₃, layer 9 ZrO₂.

17. The optically modified three-dimensional object of claim 1 having a chrome-like appearance wherein the at least one dielectric material includes 9 layers ordered as follows from a 70/30 brass substrate material having a protective nickel coating: layer 1 TiO₂, layer 2 SiO₂, layer 3 TiO₂, layer 4 SiO₂, layer 5 TiO₂, layer 6 Al₂O₃, layer 7 TiO₂, layer 8 Al₂O₃, layer 9 ZrO₂.

18. The optically modified three-dimensional object of claim 1 having a yellowish appearance wherein the at least one dielectric material includes 8 layers ordered as follows from a 70/30 brass substrate material: layer 1 TiO₂, layer 2 SiO₂, layer 3 TiO₂, layer 4 SiO₂, layer 5 TiO₂, layer 6 Al₂O₃, layer 7 TiO₂, layer 8 Al₂O₃.

19. The optically modified three-dimensional object of claim 1 having a pink/green appearance at different angle of incidence wherein the at least one dielectric material includes 8 layers ordered as follows from a 70/30 brass substrate material having a nickel protective layer: layer 1 TiO₂, layer 2 SiO₂, layer 3 TiO₂, layer 4 SiO₂ layer 5 TiO₂, layer 6 Al₂O₃, layer 7 TiO₂, layer 8 Al₂O₃.

20. The optically modified three-dimensional object of claim 1 having a chrome-like appearance wherein the at least one dielectric material includes 10 layers ordered as follows from a 70/30 brass substrate material: layer 1 SiO₂, layer 2 Al₂O₃, layer 3 TiO₂, layer 4 Al₂O₃, layer 5 TiO₂, layer 6 Al₂O₃, layer 7 TiO₂, layer 8 Al₂O₃, layer 9 TiO₂, layer 10 Al₂O₃.

21. The optically modified three-dimensional object of claim 1 having a chrome-like appearance wherein the at least one dielectric material includes 9 layers ordered as follows from a steel substrate material: layer 1 SiO₂, layer 2 TiO₂, layer 3 SiO₂, layer 4 TiO₂, layer 5 SiO₂, layer 6 TiO₂, layer 7 Al₂O₃, layer 8 TiO₂, layer 9 Al₂O₃.

22. The optically modified three-dimensional object of claim 1 having a blue appearance wherein the at least one dielectric material includes 13 layers ordered as follows from a nickel substrate material: layer 1 TiO₂, layer 2 Al₂O₃, layer 3 SiO₂, layer 4 Al₂O₃, layer 5 TiO₂, layer 6 Al₂O₃, layer 7 Ta₂O₅, layer 8 TiO₂, layer 9 Ta₂O₅, layer 10 Al₂O₃, layer 11 Ta₂O₅ layer 12 TiO₂, layer 13 SiO₂.

23. The optically modified three-dimensional object of claim 1 having a blue appearance wherein the at least one dielectric material includes 1 layer on a nickel substrate material: layer 1 TiO₂ at a thickness of 57 nanometers.

24. The optically modified three-dimensional object of claim 1 having a green appearance wherein the at least one dielectric material includes 15 layers ordered as follows from a nickel substrate material: layer 1 TiO₂, layer 2 Al₂O₃, layer 3 SiO₂, layer 4 Al₂O₃, layer 5 TiO₂, layer 6 Ta₂O₅, layer 7 TiO₂, layer 8 Al₂O₃, layer 9 Ta₂O₅, layer 10 TiO₂, layer 11 SiO₂, layer 12 Al₂O₃, layer 13 Ta₂O₅ layer 14 TiO₂, layer 15 SiO₂.

25. The optically modified three-dimensional object of claim 1 having a green appearance wherein the at least one dielectric material includes 1 layer on a nickel substrate material: layer 1 TiO₂ at a thickness of 210.9 nanometers.

26. The optically modified three-dimensional object of claim 1 having a purple appearance wherein the at least one dielectric material includes 9 layers ordered as follows from a nickel substrate material: layer 1 TiO₂, layer 2 SiO₂, layer 3 Al₂O₃, layer 4 SiO₂, layer 5 TiO₂, layer 6 Ta₂O₅ layer 7 Al₂O₃, layer 8 Ta₂O₅, layer 9 TiO₂.

27. The optically modified three-dimensional object of claim 1 having a purple appearance wherein the at least one dielectric material includes 1 layer on a nickel substrate material: layer 1 TiO₂ at a thickness of 45.6 nanometers.

28. The optically modified three-dimensional object of claim 1 wherein the substrate material includes brass having a protective nickel coating and including a layer of ZrO₂ positioned on top of the at least one dielectric material.

29. An optically modified three-dimensional object comprising:
a metal substrate material;
a plurality of alternating layers of low and high refractive index materials defining a dielectric stack on the metal substrate material;
wherein a visual property of the substrate material and visible light reflected by the at least one substrate material and plurality of alternating layers of low and high refractive index materials create a desired visual appearance of the three-dimensional object.

30. An optically modified three-dimensional object comprising:
a metal substrate material;
at least one dielectric material on the metal substrate material;
wherein a visual property of the substrate material and visible light reflected by the at least one substrate material and dielectric material has a chrome-like appearance without the use of chromium on the three-dimensional object.
